(19) United States
(12) Patent Application Publication
(10) Pub. No.: US 2016/0033704 A1
(43) Pub. Date: Feb. 4, 2016

(54) LIGHT GUIDE AND LIGHTING ASSEMBLY HAVING LIGHT REDIRECTING FEATURES

(71) Applicant: Rambus Delaware LLC, Brecksville, OH (US)

(72) Inventors: Dane A. Sahlhoff, Fremont, CA (US); Greg Coghlan, Olmsted Falls, OH (US)

(21) Appl. No.: 14/815,134

(22) Filed: Jul. 31, 2015

Related U.S. Application Data
(60) Provisional application No. 62/076,077, filed on Nov. 6, 2014.
(60) Provisional application No. 62/031,195, filed on Jul. 31, 2014.
(60) Provisional application No. 62/076,106, filed on Nov. 6, 2014.
(60) Provisional application No. 62/031,208, filed on Jul. 31, 2014.

(51) Int. Cl. F21V 8/00

(52) U.S. Cl. CPC G02B 6/0001

(57) ABSTRACT

A light guide includes a first major surface, a second major surface opposed the first major surface, and a light input edge extending between the first and second major surfaces. Micro-optical elements are at the first major surface. The micro-optical elements are embodied as protrusions from or indentations in the major surface. Each micro-optical element includes an end surface and a side surface. The micro-optical elements are configured to output 60 to 90 percent of the light incident thereon through one of the first and the second major surfaces, and are configured to output 10 to 40 percent of the light incident thereon through the other of the first and the second major surfaces.

### RELATED APPLICATION DATA

This application claims the benefit of U.S. Provisional Patent Application No. 62/031,195, filed Jul. 31, 2014; claims the benefit of U.S. Provisional Patent Application No. 61/031,208, filed Jul. 31, 2014; claims the benefit of U.S. Provisional Patent Application No. 62/076,077, filed Nov. 6, 2014; and claims the benefit of U.S. Provisional Patent Application No. 62/076,106, filed Nov. 6, 2014; the disclosures of which are incorporated herein by reference in their entireties.

### BACKGROUND

Energy efficiency has become an area of interest for energy consuming devices. One class of energy consuming devices is lighting devices. Light emitting diodes (LEDs) show promise as energy efficient light sources for lighting devices. But control over light output distribution is an issue for lighting devices that use LEDs or similar light sources.

### BRIEF DESCRIPTION OF THE DRAWINGS

FIG. 1 is a schematic perspective view of an exemplary lighting assembly.

FIGS. 2-5 are schematic cross-sectional views of parts of exemplary lighting assemblies including light extracting elements.

FIG. 6 is a schematic perspective view of another exemplary lighting assembly.

FIGS. 7 and 8 are schematic cross-sectional views of parts of exemplary lighting assemblies including light extracting elements.

FIGS. 9-12 are schematic cross-sectional views of parts of exemplary lighting assemblies including light extracting elements.

FIG. 13 is a chart showing the percentage of light emitted from a major surface from among the light output from the light guide as a function of the shape of the light extracting elements embodied as truncated football-shaped micro-optical element protrusions.

FIG. 14 is a chart showing the percentage of light emitted from a major surface from among the light output from the light guide as a function of the shape of the light extracting elements embodied as truncated v-groove protrusions.

FIGS. 15-17 are schematic cross-sectional views of parts of exemplary lighting assemblies including light extracting elements.

FIG. 18 is a chart showing the percentage of light emitted from a major surface from among the light output from the light guide as a function of the shape of the light extracting elements embodied as truncated v-groove indentations.

FIG. 19 is a schematic cross-sectional view of parts of an exemplary lighting assembly including light extracting elements.

FIG. 20 is a schematic side view of an exemplary lighting assembly.

FIGS. 21-24 are schematic cross-sectional views of parts of exemplary lighting assemblies.

### DESCRIPTION

Embodiments will now be described with reference to the drawings, wherein like reference numerals are used to refer to like elements throughout. The figures are not necessarily to scale. Features that are described and/or illustrated with respect to one embodiment may be used in the same way or in a similar way in one or more other embodiments and/or in combination with or instead of the features of the other embodiments. In this disclosure, angles of incidence, reflection, and refraction and output angles are measured relative to the normal to the surface.

In accordance with one aspect of the present disclosure, a light guide includes a first major surface; a second major surface opposed the first major surface; a light input edge extending between the first major surface and the second major surface, the first major surface and the second major surface configured to propagate light input to the light guide through the light input edge therebetween by total internal reflection; micro-optical elements at the first major surface, the micro-optical elements embodied as protrusions from the first major surface, each micro-optical element including an end surface and a side surface, wherein: the end surface is configured to reflect at least a portion of the light propagating in the light guide and incident thereon toward the side surface; and the side surface extends from the first major surface to the end surface at an angle relative to a normal to the first major surface, is configured to reflect and output the portion of the light reflected by the end surface and incident thereon through the second major surface, and is configured to output another portion of the light propagating in the light guide and incident thereon through the first major surface; and the micro-optical elements are configured to output 60 to 90 percent of the light incident thereon through one of the first and the second major surfaces, and are configured to output 10 to 40 percent of the light incident thereon through the other of the first and the second major surfaces.

In accordance with another aspect of the present disclosure, a light guide includes a first major surface; a second major surface opposed the first major surface; a light input edge extending between the first major surface and the second major surface, the first major surface and the second major surface configured to propagate light input to the light guide through the light input edge therebetween by total internal reflection; micro-optical elements at the first major surface, the micro-optical elements embodied as indentations in the first major surface, each micro-optical element including an end surface and a side surface, wherein the side surface extends from the first major surface to the end surface at an angle relative to a normal to the first major surface, is configured to output a portion of the light propagating in the light guide and incident thereon through the first major surface, and is configured to reflect and output another portion of the light incident thereon through the second major surface; and the micro-optical elements are configured to output 60 to 90 percent of the light incident thereon through one of the first and the second major surfaces, and are configured to output 10 to 40 percent of the light incident thereon through the other of the first and the second major surfaces.

With initial reference to FIG. 1, an exemplary embodiment of a lighting assembly is shown at 100. The lighting assembly 100 includes a light guide 102. The light guide 102 is a solid article of manufacture made from, for example, polycarbonate, poly(methyl-methacrylate) (PMMA), glass, or other appropriate material. The light guide 102 may also be a multi-layer light guide having two or more layers that may differ in refractive index. The light guide 102 includes a first major surface 106 and a second major surface 108 opposite the first major surface 106. The light guide 102 is configured to propagate light by total internal reflection between the first major surface 106 and the second major surface 108. The length and width dimensions of each of the major surfaces 106, 108 are greater, typically ten or more times greater, than the thickness of the light guide 102. The thickness is the dimension of the light guide 102 in a direction orthogonal to the major surfaces 106, 108. The thickness of the light guide 102 may be, for example, about 0.1 millimeters (mm) to about 10 mm.

At least one edge surface extends between the major surfaces 106, 108 of the light guide in the thickness direction. The total number of edge surfaces depends on the configuration of the light guide. In the case where the light guide is rectangular, the light guide has four edge surfaces 110, 112, 114, 116. In the embodiment shown, the light guide extends in a longitudinal direction 115 between edge surface 110 and edge surface 112; and extends in a lateral direction 117 between edge surface 114 and edge surface 116. Other light guide shapes result in a corresponding number of side edges. Although not shown, in some embodiments, the light guide 102 may additionally include one or more edge surfaces defined by the perimeter of an orifice extending through the light guide in the thickness direction. Each edge surface defined by the perimeter of an orifice extending through the light guide 102 will hereinafter be referred to as an internal edge surface. Depending on the shape of the light guide 102, each edge surface may be straight or curved, and adjacent edge surfaces may meet at a vertex or join in a curve. Moreover, each edge surface may include one or more straight portions connected to one or more curved portions. The edge surface through which light from the light source 104 is input to the light guide will now be referred to as a light input edge. In the embodiment shown in FIG. 1, the edge surface 110 is a light input edge. In some embodiments, the light guide 102 includes more than one light input edge. Furthermore, the one or more light input edges may be straight and/or curved.

In the illustrated embodiment, the major surfaces 106, 108 are planar. In other embodiments, at least a portion of the major surfaces 106, 108 of the light guide 102 is curved in one or more directions. In one example, the intersection of the light input edge 110 and one of the major surfaces 106, 108 defines a first axis, and at least a portion of the light guide 102 curves about an axis orthogonal to the first axis. In another example, at least a portion of the light guide 102 curves about an axis parallel to the first axis. Exemplary shapes of the light guide include a dome, a hollow cylinder, a hollow cone or pyramid, a hollow frustrated cone or pyramid, a bell shape, an hourglass shape, or another suitable shape.

The lighting assembly 100 includes a light source 104 positioned adjacent the light input edge 110. The light source 104 is configured to edge light the light guide 102 such that light from the light source 104 enters the light input edge 110 and propagates along the light guide 102 by total internal reflection at the major surfaces 106, 108.

The light source 104 includes one or more solid-state light emitters 118. The solid-state light emitters 118 constituting the light source 104 are arranged linearly or in another suitable pattern depending on the shape of the light input edge 110 of the light guide 102 to which the light source 104 supplies light.

Exemplary solid-state light emitters 118 include such devices as LEDs, laser diodes, and organic LEDs (OLEDs). In an embodiment where the solid-state light emitters 118 are LEDs, the LEDs may be top-fire LEDs or side-fire LEDs, and may be broad spectrum LEDs (e.g., white light emitters) or LEDs that emit light of a desired color or spectrum (e.g., red light, green light, blue light, or ultraviolet light), or a mixture of broad-spectrum LEDs and LEDs that emit narrow-band light of a desired color. In one embodiment, the solid-state light emitters 118 emit light with no operably-effective intensity at wavelengths greater than 500 nanometers (nm) (i.e., the solid-state light emitters 118 emit light at wavelengths that are predominantly less than 500 nm). In some embodiments, the solid-state light emitters 118 constituting light source 104 all generate light having the same nominal spectrum. In other embodiments, at least some of the solid-state light emitters 118 constituting light source 104 generate light that differs in spectrum from the light generated by the remaining solid-state light emitters 118. For example, two different types of solid-state light emitters 118 may be alternately located along the light source 104.

Each solid-state light emitter 118 emits light at a light ray angle distribution relative to an optical axis 119 of the solid-state light emitter 118. The optical axis 119 is defined as an axis extending orthogonally from the center of the light emitting surface of the solid state light emitter 118. The solid-state light emitter 118 may be arranged so that the optical axis 119 is perpendicular to the light input edge 110.

The lighting assembly 100 may include one or more additional components. For example, although not specifically shown in detail, in some embodiments of the lighting assembly, the light source 104 includes structural components to retain the solid-state light emitters 118. In the examples shown in FIG. 1, the solid-state light emitters 118 are mounted to a printed circuit board (PCB) 120. The light source 104 may additionally include circuitry, power supply, electronics for controlling and driving the solid-state light emitters 118, and/or any other appropriate components.

The lighting assembly 100 may additionally include a housing 122 for retaining the light source 104 and the light guide 102. The housing 122 may retain a heat sink or may itself function as a heat sink. In some embodiments, the lighting assembly 100 includes a mounting mechanism (not shown) to mount the lighting assembly to a retaining structure (e.g., a ceiling, a wall, etc.).

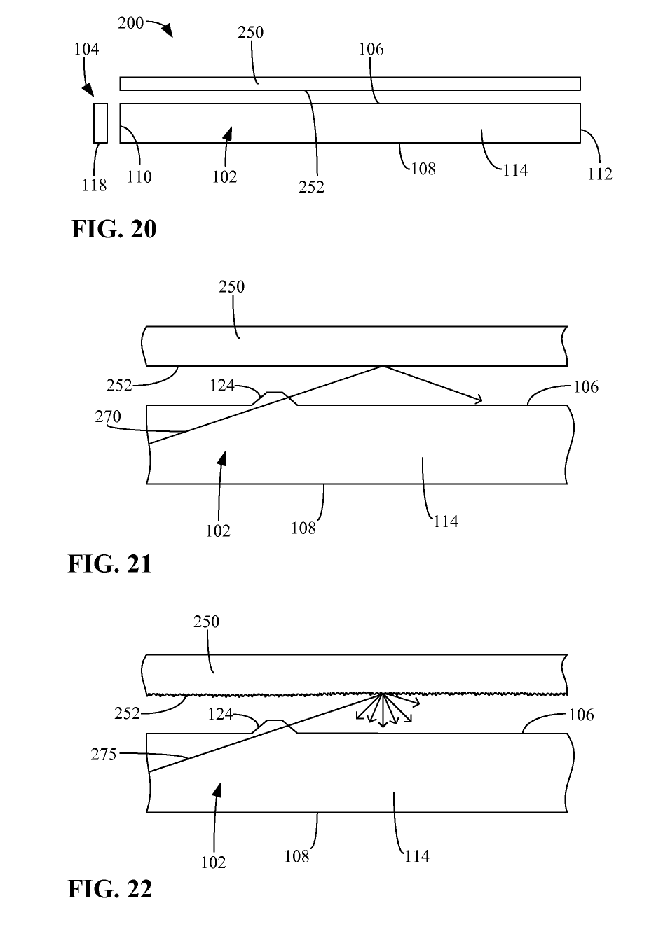

As described below, the lighting assembly 100 may additionally include a reflector 250 (FIG. 20) adjacent one of the major surfaces 106, 108. The light extracted through the major surface adjacent the reflector may be reflected by the reflector, re-enter the light guide 102 at the major surface, and be output from the light guide 102 through the other major surface.

The light guide 102 includes light extracting elements 124 in, on, or beneath at least one of the major surfaces 106, 108. Light extracting elements that are in, on, or beneath a major surface will be referred to as being “at” the major surface. Each light extracting element 124 functions to disrupt the total internal reflection of the light propagating in the light guide and incident thereon. In one embodiment, the light extracting elements 124 reflect light toward the opposing major surface so that the light exits the light guide 102 through the opposing major surface. Alternatively, the light extracting elements 124 transmit light through the light extracting elements 124 and out of the major surface of the light guide 102 having the light extracting elements 124. In another embodiment, both types of light extracting elements 124 are present. In yet another embodiment, the light extracting elements 124 reflect some of the light and refract the remainder of the light incident thereon. Therefore, the light extracting elements 124 are configured to extract light from the light guide 102 through one or both of the major surfaces 106, 108.

Exemplary light extracting elements 124 include features of well-defined shape, such as V-grooves and truncated V-grooves. Other exemplary light extracting elements 124 include micro-optical elements, which are features of well-defined shape that are small relative to the linear dimensions of the major surfaces 106, 108. The smaller of the length and width of a micro-optical element is less than one-tenth of the longer of the length and width (or circumference) of the light guide 102 and the larger of the length and width of the micro-optical element is less than one-half of the smaller of the length and width (or circumference) of the light guide 102. The length and width of the micro-optical element is measured in a plane parallel to the major surface 106, 108 of the light guide 102 for planar light guides or along a surface contour for non-planar light guides 102.

Light extracting elements 124 of well-defined shape (e.g., the above-described grooves and micro-optical elements) are shaped to predictably reflect or refract the light propagating in the light guide 102. In some embodiments, at least one of the light extracting elements 124 is an indentation (depression) of well-defined shape in the major surface 106, 108. In other embodiments, at least one of the light extracting elements 124 is a protrusion of well-defined shape from the major surface 106, 108. The light extracting elements of well-defined shape have distinct surfaces on a scale larger than the surface roughness of the major surfaces 106, 108. Light extracting elements of well-defined shape exclude features of indistinct shape or surface textures, such as printed features of indistinct shape, inkjet printed features of indistinct shape, selectively-deposited features of indistinct shape, and features of indistinct shape wholly formed by chemical etching or laser etching.

Light guides having light extracting elements of well-defined shape are typically formed by a process such as injection molding. The light extracting elements are typically defined in a shim or insert used for injection molding light guides by a process such as diamond machining, laser micromachining, photolithography, or another suitable process. Alternatively, any of the above-mentioned processes may be used to define the light extracting elements in a master that is used to make the shim or insert. In other embodiments, light guides without light extracting elements are typically formed by a process such as injection molding or extruding, and the light extracting elements are subsequently formed on one or both of the major surfaces by a process such as stamping, embossing, or another suitable process.

The light extracting elements 124 of well defined shape are configured to extract light in a defined intensity profile (e.g., a uniform intensity profile) and with a defined light ray angle distribution from one or both of the major surfaces 106, 108. In this disclosure, intensity profile refers to the variation of intensity with regard to position within a light-emitting region (such as the major surface or a light output region of the major surface). The term light ray angle distribution is used to describe the variation of the intensity of light with ray angle (typically a solid angle) over a defined range of light ray angles. In an example in which the light is emitted from an edge-lit light guide, the light ray angles can range from −90° to +90° relative to the normal to the major surface. Each light extracting element 124 of well defined shape includes at least one surface configured to refract or reflect light propagating in the light guide 102 and incident thereon such that the light is extracted from the light guide. Such surface(s) is also herein referred to as a light-redirecting surface.

In the example shown in FIG. 1, the light extracting elements 124 are embodied as truncated micro-optical elements having an arcuate end surface, herein after referred to as “truncated football-shaped” micro-optical elements. A football-shaped micro-optical element resembles the profile of the ball used in American football, and such shape is regarded as a “truncated” shape in that the shape includes an end surface 130 instead of a ridge that joins the opposed side surfaces. More specifically, each truncated football-shaped micro-optical element 124 includes opposed and oppositely sloping first and second side surfaces 126, 128, and an end surface 130 intersecting the first and second side surfaces 126, 128. The end surface 130 is arcuate in shape along its length (extending along its longitudinal axis 132) and has ends that intersect the one of the major surfaces 106, 108 at which the micro-optical element 124 is formed. The width of the end surface 130 (extending orthogonal to its longitudinal axis 132) is parallel to the plane of the major surface. In some embodiments, at least one of the first side surface 126 and the second side surface 128 is curved. In other embodiments, at least one of the first side surface 126 and the second side surface 128 is planar. In some embodiments, the first side surface 126 and the second side surface 128 are symmetric relative to a plane extending parallel to and intersecting the end surface 130 (along the longitudinal axis 132), and extending normal to the major surface. In other embodiments, the first side surface 126 and the second side surface 138 are asymmetric relative to a plane extending parallel to and intersecting the end surface 130, and extending normal to the major surface.

The included angle formed between the first side surface 126 and the second side surface 128 may be any suitable angle. As an example, the included angle of the respective football-shaped micro-optical elements 124 (i.e., the angle formed between the side surfaces 126, 128) may range from 15 degrees to 175 degrees. The included angle may be set for extracting light from the light guide 102 at a defined intensity profile and/or light ray angle distribution.

As described above, micro-optical elements are small relative to the linear dimensions of the major surfaces 106, 108. As an example, the truncated football-shaped micro-optical element shown in FIG. 1 may have a length (i.e., extending parallel to the longitudinal axis 132) ranging from 300 μm to 1000 μm. In another example, the truncated football-shaped micro-optical element shown in FIG. 1 may have a length (i.e., extending parallel to the longitudinal axis 132) ranging from 500 μm to 800 μm. In another example, the truncated football-shaped micro-optical element shown in FIG. 1 may have a length (i.e., extending parallel to the longitudinal axis 132) ranging from 650 μm to 750 μm.

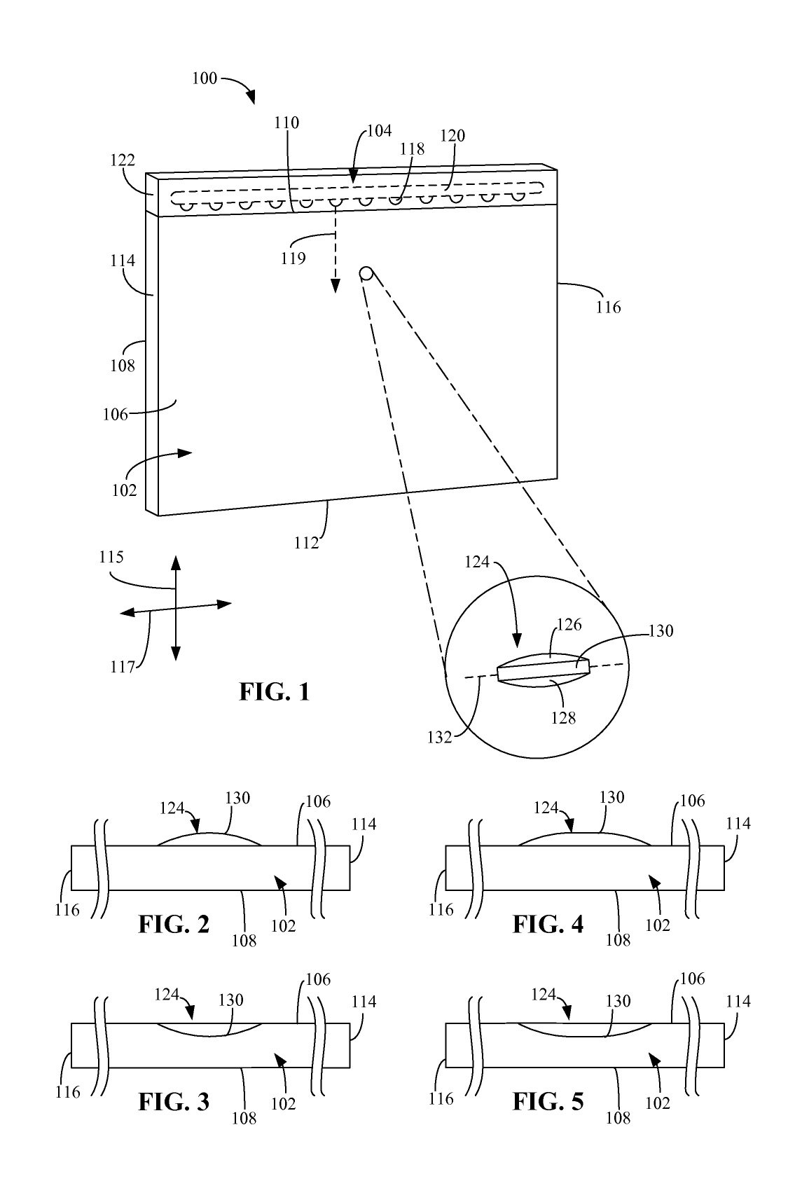

As described above, in some embodiments, the light extracting elements 124 are embodied as a protrusion of well defined shape from the major surface 106, 108. FIG. 2 shows a cross-sectional view of a portion of the light guide 102 including a light extracting element 124 embodied as a truncated football-shaped micro-optical element micro-optical element protruding from the major surface 106 (e.g., as viewed from the light input edge). In other embodiments, the light extracting elements 124 are embodied as an indentation of well defined shape from the major surface 106, 108. FIG. 3 shows a cross-sectional view of a portion of the light guide 102 including a light extracting element 124 embodied as a truncated football-shaped micro-optical element indented in the major surface 106 (e.g., as viewed from the light input edge). As shown in FIGS. 2 and 3, in some embodiments, the end surface 130 has a uniform radius along its length (extending along its longitudinal axis 132). In other embodiments, shown in FIGS. 4 and 5, the truncated football-shaped micro-optical element includes a non-uniform radius along its length (extending along its longitudinal axis 132). As shown in FIGS. 4 and 5, the end surface 130 includes a planar middle portion along its length in between two curved portions. The truncated football-shaped micro-optical element having this shape may also be described as a dragged shape.

In other embodiments, the light guide 102 may include micro-optical elements having other suitable shapes. In an example, one or more of the micro-optical elements may be configured as a protrusion or depression in the shape of a dragged truncated cone (not shown) having a pair of opposed oppositely sloping planar sides and opposed oppositely rounded or curved ends, and a planar top intersecting the oppositely sloping sides and oppositely rounded ends. In another example, one or more of the micro-optical elements may be configured as a protrusion or depression in the shape of truncated cones or truncated pyramids. Other exemplary micro-optical elements 124 are described in U.S. Pat. No. 6,752,505, the entire content of which is incorporated by reference, and, for the sake of brevity, are not described in detail in this disclosure.

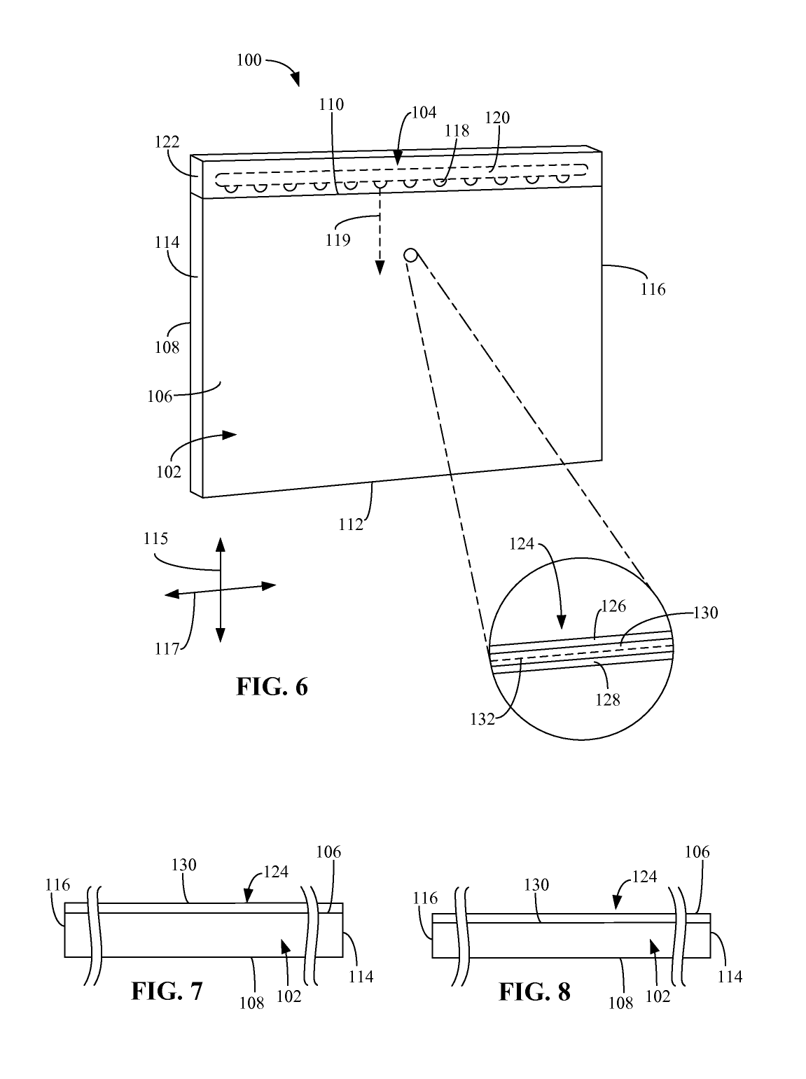

In the example shown in FIG. 6, the light extracting elements 124 are embodied as truncated V-grooves. The V-groove is regarded as a “truncated” shape in that it includes an end surface 130 instead of a ridge that joins the opposed side surfaces. More specifically, each truncated V-groove includes opposed and oppositely sloping first and second side surfaces 126, 128, and an end surface 130 intersecting the first and second side surfaces 126, 128. The width of the end surface 130 (extending orthogonal to its longitudinal axis 132) is parallel to the plane of the major surface. In some embodiments, the first side surface 126 and the second side surface 128 are symmetric relative to a plane extending parallel to and intersecting the end surface 130 (along the longitudinal axis 132), and extending normal to the major surface. In other embodiments, the first side surface 126 and the second side surface 138 are asymmetric relative to a plane extending parallel to and intersecting the end surface 130, and extending normal to the major surface.

With additional reference to FIGS. 7 and 8, the V-groove can be embodied as a protrusion of well defined shape from the major surface, or can be embodied as an indentation (depression) of well defined shape in the major surface 108. FIGS. 7 and 8 each show a cross-sectional view (e.g., as viewed from the light input edge) of a portion of the light guide 102 including a light extracting element 124 embodied as a V-groove protruding from the major surface (FIG. 7) or indented in the major surface 106 (FIG. 8). As further shown in FIGS. 7 and 8, the V-groove can extend the entire width of the light guide (e.g., in the lateral direction 117 between edge surface 114 and edge surface 116). In other embodiments, the V-groove may not extend the entire width of the light guide, but may extend a portion such as a majority of the width of the light guide (e.g., in the lateral direction 117 between edge surface 114 and edge surface 116).

In some embodiments, at least a portion of the light extracting elements 124 each include a longitudinal axis. The longitudinal axis extends in a plane parallel to the major surface 106, 108 of the light guide 102 for planar light guides or along a surface contour for non-planar light guides 102. With reference to FIG. 1, each truncated football-shaped micro-optical element includes a longitudinal axis 132 extending parallel to the ridge 130. With reference to FIG. 6, each V-groove includes a longitudinal axis 132 extending parallel to the ridge 130. In other embodiments where the light extracting element is a shape other than the truncated football shape or the truncated V-groove, the longitudinal axis may be defined by one of the length or width of the micro-optical element in a plane parallel to the major surface 106, 108 of the light guide 102 for planar light guides or along a surface contour for non-planar light guides 102. As an example, for a dragged truncated cone (not shown), the longitudinal axis may extend along its length and intersect its oppositely rounded ends.

In some embodiments, the longitudinal axis extends along the longer of the length or width of the light extracting element. In other embodiments, the longitudinal axis extends along the shorter of the length or width of the light extracting element. In some embodiments where the length and the width of the light extracting element are the same (e.g., a micro-optical element having a square base), the longitudinal axis may extend along one of the length or the width of the light extracting element. The longitudinal axis may be arranged closer to parallel to the light input edge than an axis extending perpendicular to the longitudinal axis and along the other of the length or width of the light extracting element.

The longitudinal axis is distinguishable from other axes of the light extracting element extending in a plane parallel to the major surface 106, 108 of the light guide 102 for planar light guides or along a surface contour for non-planar light guides 102. Accordingly, some micro-optical elements (e.g., a conical or frustoconical micro-optical element having a circular base) may not have a distinguishable longitudinal axis.

In some embodiments, the light extracting elements 124 provided at the major surface have the same or nominally the same shape, size, depth, height, slope angle, included angle, surface roughness, and/or index of refraction. The term “nominally” encompasses variations of one or more parameters that fall within acceptable tolerances in design and/or manufacture. As an example, each of the light extracting elements 124 may have the same or nominally the same truncated football shape shown in FIG. 1. In another example, each of the light extracting elements may have the same or nominally the same V-groove shape shown in FIG. 6. In other embodiments, the light extracting elements may vary in one or more of shape, size, depth, height, slope angle, included angle, surface roughness, and/or index of refraction. This variation in light extracting elements may achieve a desired light output from the light guide over the corresponding major surface(s). Accordingly, the reference numeral 124 will be generally used to collectively refer to the different embodiments of light extracting elements.

In some embodiments, the light extracting elements 124 (e.g., the first side surface 126, the second side surface 128, and the end surface 130) have a low surface roughness. In this disclosure, the term “low surface roughness” refers to a defined surface roughness suitable for specularly reflecting or refracting incident light. In one embodiment, the low surface roughness is an average surface roughness (R_{a-low}) less than about 10.0 nm as measured in an area of 0.005 mm². In another embodiment, the low surface roughness is an average surface roughness (R_{a-low}) less than about 5.0 nm as measured in an area of 0.005 mm². In another embodiment, the low surface roughness is an average surface roughness (R_{a-low}) less than about 1.0 nm as measured in an area of 0.005 mm². A light extracting element with all of its surfaces having a low surface roughness will also be referred to as a low surface roughness light extracting element. As an example, in some embodiments, the low surface roughness light extracting elements may have an average surface roughness (R_{a-low}) ranging from about 0.5 nm to about 5.0 nm as measured in an area of 0.005 mm².

For some lighting applications, it is desired to emit specific percentages of light input to the light guide 102 from the respective major surfaces 106, 108. As an example, a first percentage of the input light may be extracted from the first major surface 106 and a second percentage of the input light may be extracted from the second major surface 108. In the context of a lighting fixture such as a ceiling fixture, the lighting assembly may be oriented so that the first major surface 106 faces in an upward direction and the second major surface 108 faces in a downward direction. Light extracted through the first major surface 106 may be emitted in the upward direction, and light extracted through the second major surface 108 may be emitted in the downward direction. Accordingly, the light extracted through the first major surface 106 will also be referred to herein as “upward light” and the light extracted through the second major surface 108 will also be referred to herein as “downward light”. Such terms will be used in the present disclosure to refer to the light extracted through the first major surface 106 and the light extracted through the second major surface 108, respectively, although embodiments of the lighting assembly may not necessarily be oriented with the major surfaces 106, 108 facing in an upward and downward direction. The upward and downward directions referred to herein are intended to represent the opposed emission directions from the major surfaces 106, 108 of the light guide.

In some embodiments, the light guide can include a mix of light extracting elements configured to extract light from the first major surface 106 and light extracting elements configured to extract light from the second major surface 108. Such a mix of light extracting elements may help to control the light ray angle distribution from each of the first major surface 106 and the second major surface 108. However, patterning the mix of the light extracting elements at the major surface can be complex, and it can also be difficult to achieve a desired intensity profile (e.g., a uniform intensity profile). With some conventional light extracting elements it is possible to split light output therefrom between the major surfaces 106, 108 (e.g., in the upward and downward directions), but such conventional elements are typically limited to up/down split ratios of about 50/50 to about 60/40. In many lighting applications, it is desirable to provide a different split ratio of the light output between upward and downward directions.

In accordance with the present disclosure, light extracting elements are provided that are configured to split light output between the major surfaces 106, 108 at ratios greater than the conventional 50/50 to 60/40 split ratios. By controlling the specific shape geometries of the light extracting element (e.g., the light extracting elements as described above and shown in FIGS. 1-8) the split ratio may be provided at a desired range.

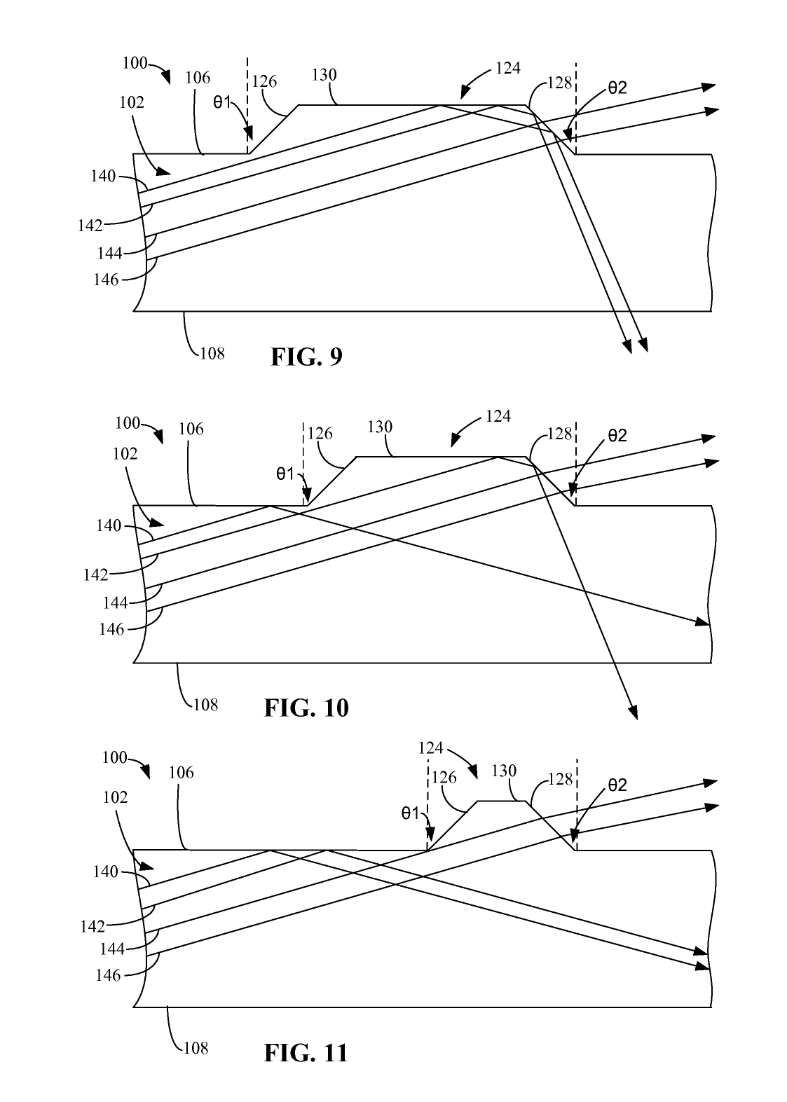

FIGS. 9-11 each show a cross-sectional view (e.g., as viewed from the lateral direction 117) of a portion of the light guide 102 including a light extracting element 124. The truncated football-shaped micro-optical element described above in FIGS. 1, 2, and 4 and the truncated V-groove described above in FIGS. 6 and 7 have a similar cross-sectional profile in the lateral direction 117. Accordingly, for each of FIGS. 9-11, the light extracting element can be either of a truncated football-shaped protrusion (similar to the shape shown in FIGS. 1, 2, and 4), or a truncated V-groove (similar to the shape shown in FIGS. 6 and 7). In each of the figures, the light extracting element protrudes from the first major surface 106 of the light guide 102. The width of the end surface 130 extends nominally parallel to the major surface 106 of the light guide. The side surface 126 extends from the major surface 106 to the end surface 130 at an angle θ1 relative to the normal of the major surface. The side surface 128 extends from the major surface 106 to the end surface 130 at an angle θ2 relative to the normal of the major surface 106. In FIGS. 9-11, the longitudinal axis 132 of the light extracting element is normal to the plane of the page. The end surface 130 is configured to reflect at least a portion of the light propagating in the light guide and incident thereon toward the at least one side surface. The side surface 128 is configured to output another portion of the light propagating in the light guide and incident thereon through the first major surface 106. The side surface 128 is also configured to output the portion of the light reflected by the end surface 130 and incident thereon by reflecting the portion of the light toward the second major surface 108.

As shown in FIGS. 9-11, the angles θ1 and θ2 are the same (e.g., each about) 45°. However, the width of the end surface 130 in the direction orthogonal to the longitudinal axis is different in each of the figures. Specifically, the width of the end surface 130 in the direction orthogonal to the longitudinal axis is largest in FIG. 9 and is smallest in FIG. 11. Exemplary light rays 140, 142, 144, 146 are shown in each of FIGS. 9-11 to illustrate how the propagating light can interact with the light extracting element, and how this interaction can change as a function of the width of the end surface 130. Each of the exemplary light rays 140, 142, 144, 146 propagates in the light guide 102 at similar modes of propagation. Other modes of light propagating in the light guide 102 may be affected in a similar manner.

In FIG. 9 both of light rays 140 and 142 propagate in the light guide and are incident the end surface 130. The light 140, 142 is reflected at the end surface 130 and is incident the side surface 128. The light 140, 142 is further reflected at the side surface 128 and is output through the major surface 108 of the light guide 102 (e.g., extracted as downward light). Light rays 144 and 146 each propagate in the light guide 102 and are initially incident the side surface 128. The light is refracted and is output through the major surface 106 of the light guide 102 (e.g., extracted as upward light).

In FIG. 10, the width of the end surface 130 is smaller than the width shown in FIG. 9. Light ray 140 propagates in the light guide 102 and is incident the major surface 106. Because the micro-optical element is smaller due to the reduction in width of the end surface 130, the light 140 is not incident the micro-optical element at all. Accordingly, light 140 continues to propagate in the light guide 102 by total internal reflection. Light ray 142 propagates in the light guide 102 and is incident the end surface 130. The light 142 is reflected at the end surface 130 and is incident the side surface 128. The light 142 is further reflected at the side surface 128 and is output through the major surface 108 of the light guide 102 (e.g., extracted as downward light). Light rays 144 and 146 each propagate in the light guide 102 and are initially incident the side surface 128. The light is refracted and is output through the major surface 106 of the light guide 102 (e.g., extracted as upward light). Accordingly, in the embodiment shown in FIG. 10, less light is reflected and output through the major surface 108 as compared with the light that is reflected and output through the major surface 108 in FIG. 9.

In FIG. 11, the width of the end surface 130 is smaller than the respective widths shown in FIGS. 9 and 10. Light rays 140, 142 propagate in the light guide and are incident the major surface 106. Because the micro-optical element 124 is smaller due to the reduction in width of the end surface 130, the light 140, 142 is not incident the micro-optical element at all. Accordingly, light 140, 142 continues to propagate in the light guide 102 by total internal reflection. Light rays 144 and 146 each propagate in the light guide 102 and are initially incident the side surface 128. The light is refracted and is output through the major surface 106 of the light guide 102 (e.g., extracted as upward light). Accordingly, in the embodiment shown in FIG. 11, less light is reflected and output through the major surface 108 as compared with the light that is reflected and output through the major surface 108 in FIG. 9 and in FIG. 10.

Hence, FIGS. 9-11 show that the amount of area for reflection off the end surface 130 can be controlled by varying a dimension of the end surface (i.e., by varying the width of the end surface). As this dimension of the end surface 130 is decreased, the amount of light that is able to reflect off the end surface before interacting with the side wall of the light extracting element is also decreased. Accordingly, a smaller percentage of light is extracted through the major surface 108 by reflection.

In one example, the width of the end surface 130 in the direction orthogonal to the longitudinal axis of the micro-optical element is 5 μm to 500 μm. In another example, the dimension of the end surface 130 in the direction orthogonal to the longitudinal axis of the micro-optical element is 25 μm to 200 μm. In another example, the dimension of the end surface 130 in the direction orthogonal to the longitudinal axis of the micro-optical element is 100 μm to 200 μm.

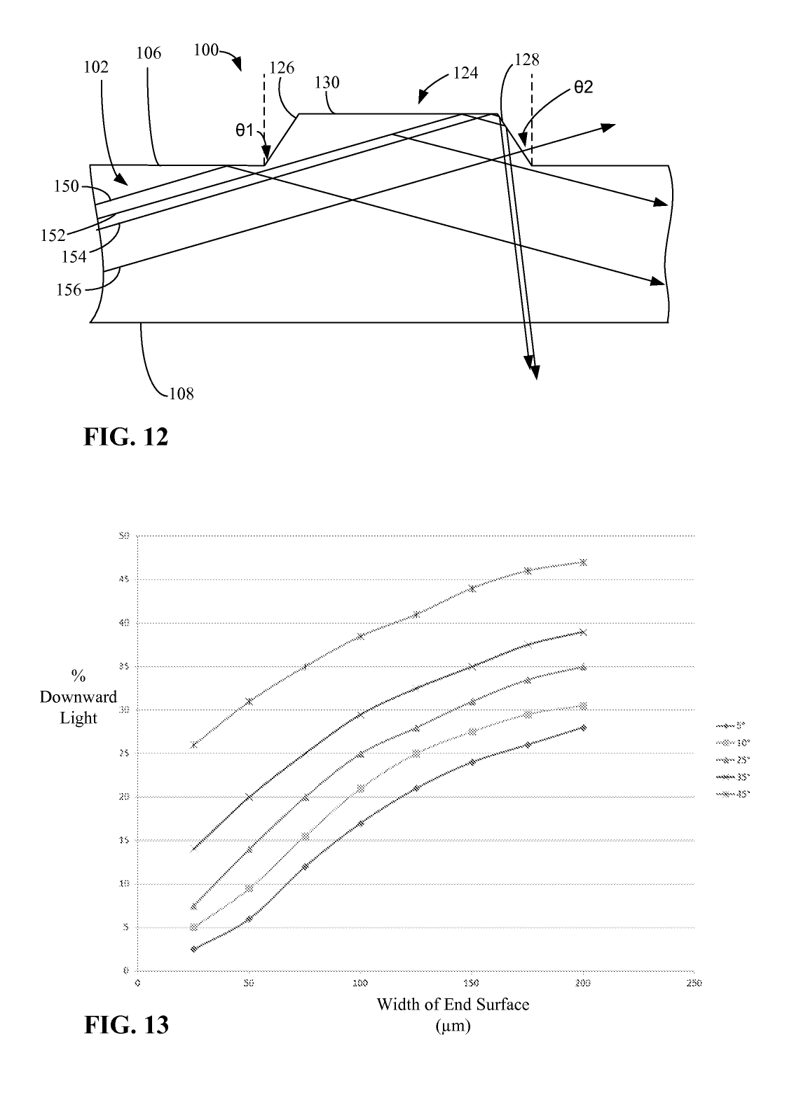

With additional reference to FIG. 12, the respective percentages of light extracted from the major surfaces 106, 108 can be controlled by varying the angle of one or more of the side surfaces 126, 128 relative to the major surface. FIG. 12 shows parts of a lighting assembly 100 including an exemplary light extracting element 124 embodied as a truncated football-shaped protrusion similar to that shown in FIGS. 9-11. The width of the end surface 130 is similar to that shown in FIG. 10. However, the angles θ1 and θ2 are less than the angles θ1 and θ2 in FIGS. 9-11 (e.g., about 35°).

As shown, light ray 150 propagates in the light guide and is incident the major surface 106 and continues to propagate in the light guide 102 by total internal reflection. Light rays 152 and 154 propagate in the light guide 102, are incident the end surface 130, and are reflected. Because the side surface 128 is closer to parallel to the normal of the major surface 106 than the side surface 128 shown in FIGS. 9-11, the light 152 and 154 incident the side surface 128 is reflected at the side surface 128 and is output through the major surface 108 of the light guide 102 (e.g., extracted as downward light) at an angle different than that shown in FIGS. 9 and 10. However, because of the different angle of the side surface 128 shown in FIG. 12, other modes of propagating light that is reflected by the end surface 130 may be refracted and output through the side surface 128 instead of being reflected. Light ray 156 propagates in the light guide 102 and is initially incident the side surface 128. The light is refracted and output through the major surface 106 of the light guide 102 (e.g., extracted as upward light).

Accordingly, variation of the angle between the side surface and the major surface may also be used to control the split ratio. In one example, the angle between the side surface 128 and the normal to the major surface 106 may be 5° to 85°. In another example, the angle between the side surface 128 and the normal to the major surface 106 may be 5° to 65°. In another example, the angle between the side surface 128 and the normal to the major surface 106 may be 5° to 45°. In another example, the angle between the side surface 128 and the normal to the major surface 106 may be 5° to 35°. In another example, the angle between the side surface 128 and the normal to the major surface 106 may be 15° to 35°.

Hence, the amount of light that is output through the light extracting element 124 through at the major surface 106 and the amount of light that is reflected by the light extracting element 124 and output from the light guide through the opposing major surface 108 may be controlled by the width of the end surface 130 in the direction orthogonal to the longitudinal axis 132, and by the angle of the side surface relative to the major surface. By configuring these parameters of the light extracting element in the appropriate manner, a desired split ratio of light emitted in the upward direction and the downward direction may be achieved.

In some embodiments, the light extracting element 124 is configured to output at least 60 percent of the light incident thereon through the major surface at which the micro-optical element is provided (e.g., as upward light); and is configured to output at most 40 percent of the light incident thereon through the opposing major surface (e.g., as downward light). For example, the light extracting element 124 may be configured to output between 60 to 90 percent of the light incident thereon through the major surface at which the light extracting element is provided (e.g., as upward light), and may output between 10 and 40 percent of the light incident thereon through the opposing major surface (e.g., as downward light). In other embodiments, the light extracting element 124 is configured to output at least 70 percent of the light incident thereon through the major surface at which the light extracting element is provided; and is configured to output at most 30 percent of the light incident thereon through the opposing major surface. For example, the light extracting element 124 may be configured to output between 70 to 90 percent of the light incident thereon through the major surface at which the light extracting element is provided, and may output between 10 and 30 percent of the light incident thereon through the opposing major surface. In other embodiments, the light extracting element 124 is configured to output at least 80 percent of the light incident thereon through the major surface at which the light extracting element is provided; and is configured to output at most 20 percent of the light incident thereon through the opposing major surface. For example, the light extracting element 124 may be configured to output between 80 to 90 percent of the light incident thereon through the major surface at which the light extracting element is provided, and may output between 10 and 20 percent of the light incident thereon through the opposing major surface.

In the embodiments described above, it will be understood that the amount of light that is output through the light extracting element 124 at the major surface 106 and the amount of light that is reflected by the light extracting element 124 and output from the light guide through the opposing major surface 108 may not total 100% of the light incident on the light extracting element 124. For example, a portion of the light propagating in the light guide 102 and incident the light extracting element 124 may be totally internally reflected and continue to propagate in the light guide 102.

FIG. 13 shows simulation results in which the percentage of light reflected by the side surface 128 (% Downward Light) is varied as a function of both the width of the end surface 130 in the direction orthogonal to the longitudinal axis 132 and the angle of the side surface 128 relative to the normal to the major surface 106. In the simulation shown in FIG. 13, the light extracting elements 124 are embodied as truncated football-shaped micro-optical element protrusions similar to that shown in FIGS. 1 and 2. The width of the end surface 130 in the direction orthogonal to the longitudinal axis 132 ranges from 25 μm to 200 μm. The angle of the side surface 128 relative to the major surface 106 ranges from 5° to 45°. As shown, the percentage of downward light (i.e., light reflected by the side surface 128 and output from the major surface 108) increases with both the increase in the width of the end surface 130 and with the angle of the side surface 128.

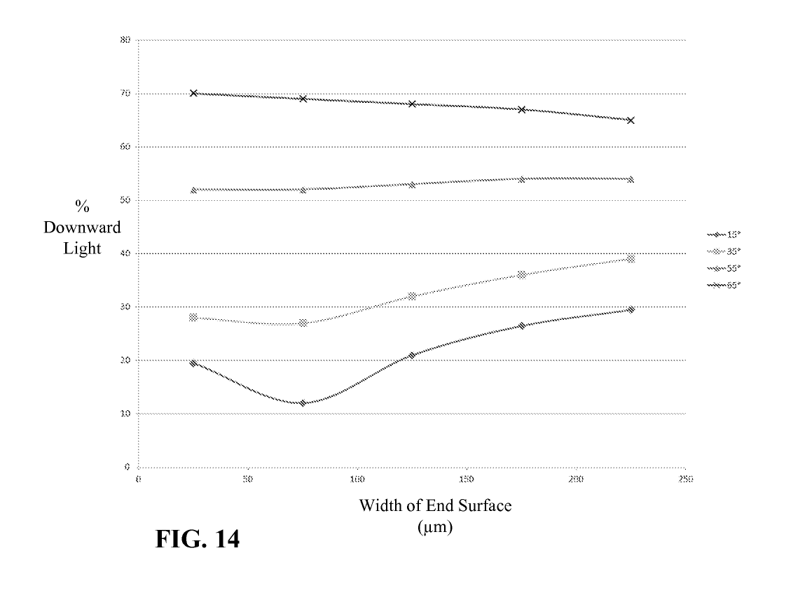

FIG. 14 shows additional simulation results in which the percentage of light reflected by the side surface 128 (% Downward Light) is varied as a function of both the width of the end surface 130 in the direction orthogonal to the longitudinal axis 132 and the angle of the side surface 128 relative to the normal to the major surface 106. In the simulation shown in FIG. 14, the light extracting elements 124 are embodied as truncated V-groove protrusions similar to that shown in FIGS. 6 and 7. The width of the end surface 130 in the direction orthogonal to the longitudinal axis 132 ranges from 25 μm to 250 μm. The angle of the side surface 128 relative to the major surface 106 ranges from 15° to 65°. As shown, for the lower angles (15° and 35°), the percentage of downward light (i.e., light reflected by the side surface 128 and output from the major surface 108) increases with both the increase in the width of the end surface 130 and with the angle of the side surface 128. At the higher angle of 55°, there is only a slight increase as the width of the end surface 130 is increased. Furthermore, at the angle of 65°, there is a slight decrease as the width of the end surface 130 is increased. This difference shown at the higher angles may be a result of the light reflected by the end surface 130 being refracted and output through the side surface 128 (as described above).

FIG. 14 also exemplifies that, in some embodiments, the light extracting element 124 is configured to output at most 40 percent of the light incident thereon through the major surface at which the micro-optical element is provided (e.g., as upward light); and is configured to output at least 60 percent of the light incident thereon through the opposing major surface (e.g., as downward light). For example, the light extracting element 124 may be configured to output between 10 to 40 percent of the light incident thereon through the major surface at which the light extracting element is provided (e.g., as upward light), and may output between 60 to 90 percent of the light incident thereon through the opposing major surface (e.g., as downward light).

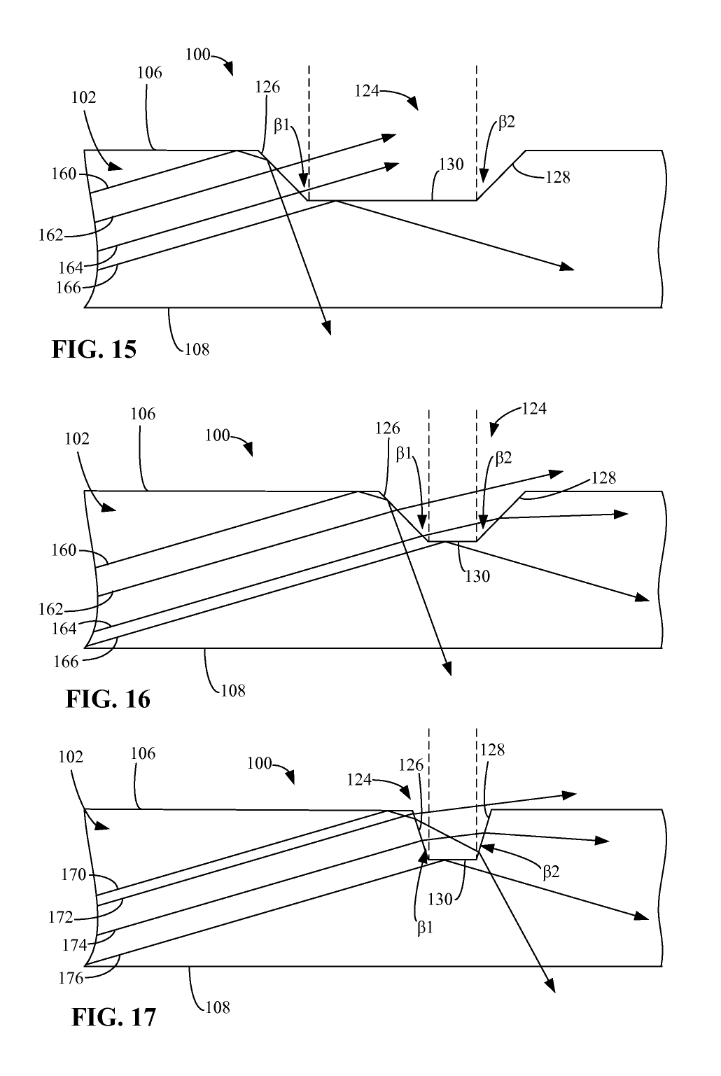

In the embodiments described above, the light extracting element 124 is embodied as a protrusion. With reference to FIGS. 15 and 16, the light extracting element 124 may be embodied as an indentation. FIGS. 15 and 16 each show a cross-sectional view (e.g., as viewed from the lateral direction 117) of a portion of the light guide 102 including a light extracting element 124. The truncated football-shaped micro-optical element and the truncated V-groove have a similar cross-sectional profile. Accordingly, for each of FIGS. 15 and 16, the light extracting element 124 can be embodied as a truncated football-shaped indentation (similar to the shape shown in FIGS. 1, 3, and 5), or a truncated V-groove (similar to the shape shown in FIGS. 6 and 8). The width of the end surface 130 extends nominally parallel to the major surface 106 of the light guide 102. The side surface 126 extends from the major surface 106 to the end surface 130 at an angle β1 relative to the normal to the major surface. The side surface 128 extends from the major surface 106 to the end surface 130 at an angle β2 relative to the normal to the major surface 106. In FIGS. 15 and 16, the longitudinal axis 132 is normal to the plane of the page. The side surface 126 is configured to output a portion of the light propagating in the light guide and incident thereon from the first major surface 106. The side surface 126 is also configured to reflect and output another portion of the light propagating in the light guide and incident thereon from the first major surface 108.

As shown in FIGS. 15 and 16, the angles β1 and β2 are the same (e.g., about) 45°. However, the width of the end surface 130 in the direction orthogonal to the longitudinal axis is different in each of the figures. Exemplary light rays 160, 162, 164, 166 are shown in each of FIGS. 15 and 16 to illustrate how the light can interact with the light extracting element, and how this interaction can change as a function of the width of the end surface 130. Each of the exemplary light rays 160, 162, 164, 166 propagates in the light guide 102 at similar modes of propagation. Other modes of light propagating in the light guide 102 may be affected in a similar manner.

In FIG. 15, light ray 160 propagates in the light guide 102 and is totally internally reflected at the major surface 106 before being incident the side surface 126. The light 160 is reflected at the side surface 126 and is output through the major surface 108 of the light guide 102 (e.g., extracted as downward light). The light rays 162, 164 propagate in the light guide 102 and are initially incident the side surface 126. The light 162, 164 is refracted and is output through the major surface 106 of the light guide 102 (e.g., extracted as upward light). The light ray 166 is incident the end surface 130, is reflected, and continues to propagate in the light guide by total internal reflection.

In FIG. 16, the width of the end surface 130 is smaller than the width shown in FIG. 15. Light ray 160 propagates in the light guide 102 and is totally internally reflected at the major surface 106 before being incident the side surface 126. The light 160 is reflected at the side surface 126 and is output through the major surface of the light guide 102 (e.g., extracted as downward light). The light ray 162 propagates in the light guide 102 and is initially incident the side surface 126. The light 162 is refracted and is output through the major surface 106 of the light guide 102 (e.g., extracted as upward light). The light ray 164 propagates in the light guide 102 and is initially incident the side surface 126. The light 164 is refracted and is output through the major surface 106 of the light guide 102. But because the width of the end surface 130 is smaller, the light 164 is incident the side surface 128 and is refracted back into the light guide 102. In some embodiments, the light 164 continues to propagate in the light guide. In other embodiments, the light 164 is output from the second major surface 108. The light ray 166 is incident the end surface 130, is reflected, and continues to propagate in the light guide by total internal reflection.

Hence, FIGS. 15 and 16 show that the width of the end surface 130 can affect how the incident light interacts with the light extracting element. For example, as the width of the end surface 130 decreases, the amount of light that is refracted by the side surface 126 and output from the major surface 106 without being incident the side surface 128 is also decreased.

In one example, the width of the end surface 130 in the direction orthogonal to the longitudinal axis of the light extracting element is 5 μm to 500 μm. In another example, the dimension of the end surface 130 in the direction orthogonal to the longitudinal axis of the light extracting element is 25 μm to 200 μm. In another example, the dimension of the end surface 130 in the direction orthogonal to the longitudinal axis of the light extracting element is 100 μm to 200 μm.

With additional reference to FIG. 17, the respective percentages of light extracted from the major surfaces 106, 108 can be controlled by varying the angle of one or more of the side surfaces 126, 128 relative to the normal to the major surface 106. FIG. 17 shows parts of a lighting assembly 100 including an exemplary light extracting element 124 similar to that shown in FIGS. 15 and 16. The width of the end surface 130 is similar to that shown in FIG. 16. However, the angles β1 and β2 are less than the angles β1 and β2 in FIGS. 15 and 16.

As shown, light ray 170 propagates in the light guide 102 and is totally internally reflected at the major surface 106 before being incident the side surface 126. The light 170 is refracted at the side surface 126 and reenters the light guide at side surface 128. The light 170 is output through the major surface 108 of the light guide 102 (e.g., extracted as downward light). The light ray 172 propagates in the light guide 102 and is initially incident the side surface 126. The light 172 is refracted and is output through the major surface 106 of the light guide 102 (e.g., extracted as upward light). The light ray 174 propagates in the light guide 102 and is initially incident the side surface 126. The light 174 is refracted at the side surface 126 and reenters the light guide at side surface 128. In the embodiment shown, the light 174 continues to propagate in the light guide. In other embodiments, the light 174 is output from the second major surface 108. The light ray 176 is incident the end surface 130, is reflected, and continues to propagate in the light guide by total internal reflection.

Accordingly, variation of the angle between the side surface and the major surface may also be used to control the split ratio. For example, as the angle decreases, less light may be refracted at the side surface 126 may instead continue to propagate in the light guide. In one example, the angle between the side surface and the major surface 106 may be 5° to 85°. In another example, the angle between the side surface and the major surface 106 may be 15° to 65°. In another example, the angle between the side surface 128 and the major surface 106 may be 15° to 45°.

Hence, the amount of light that is output through the light extracting element 124 at the major surface 106 and the amount of light that is reflected by the light extracting element 124 and output from the light guide 102 through the opposing major surface 108 may be controlled by the width of the end surface 130 in the direction orthogonal to the longitudinal axis 132 and by the angle of the side surface relative to the major surface. By configuring these parameters of the light extracting element in the appropriate manner, a desired split ratio of light emitted in the upward direction and the downward direction may be achieved.

In some embodiments, the light extracting element 124 is configured to output at least 60 percent of the light incident thereon through the major surface at which the light extracting element is provided (e.g., as upward light); and is configured to output at most 40 percent of the light incident thereon through the opposing major surface (e.g., as downward light). For example, the light extracting element 124 may be configured to output between 60 to 90 percent of the light incident thereon through the major surface at which the light extracting element is provided (e.g., as upward light), and may output between 10 to 40 percent of the light incident thereon through the opposing major surface (e.g., as downward light). In other embodiments, the light extracting element 124 is configured to output at least 70 percent of the light incident thereon through the major surface at which the light extracting element is provided (e.g., as upward light); and is configured to output at most 30 percent of the light incident thereon through the opposing major surface (e.g., as downward light). For example, the light extracting element 124 may be configured to output between 70 to 90 percent of the light incident thereon through the major surface at which the light extracting element is provided (e.g., as upward light), and may output between 10 to 30 percent of the light incident thereon through the opposing major surface (e.g., as downward light). In other embodiments, the light extracting element 124 is configured to output at least 80 percent of the light incident thereon through the major surface at which the light extracting element is provided (e.g., as upward light); and is configured to output at most 20 percent of the light incident thereon through the opposing major surface (e.g., as downward light). For example, the light extracting element 124 may be configured to output between 80 to 90 percent of the light incident thereon through the major surface at which the light extracting element is provided (e.g., as upward light), and may output between 10 to 20 percent of the light incident thereon through the opposing major surface (e.g., as downward light).

In the embodiment described above, it will be understood that the amount of light that is output through the light extracting element 124 through at the major surface 106 and the amount of light that is reflected by the light extracting element 124 and output from the light guide through the opposing major surface 108 may not total 100% of the light that is incident thereon. For example, a portion of the light propagating in the light guide and incident the light extracting element 124 may be totally internally reflected and continue to propagate in the light guide 102.

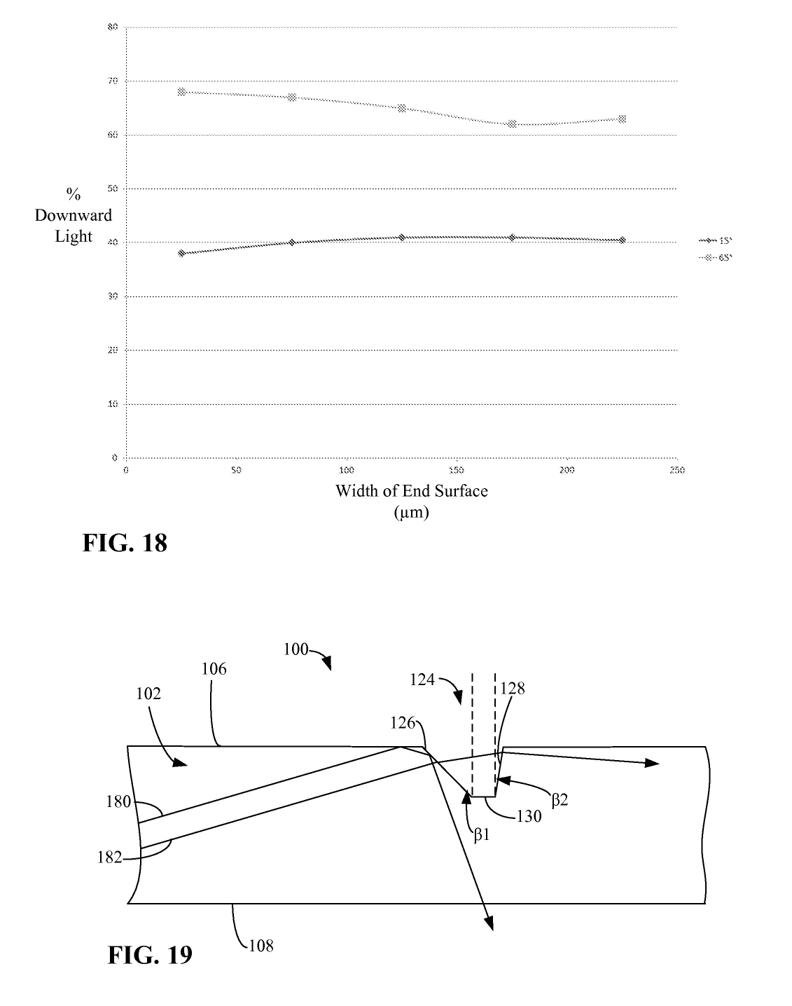

FIG. 18 shows simulation results in which the percentage of light output through the second major surface 108 (% Down Light) is varied as a function of both the width of the end surface 130 in the direction orthogonal to the longitudinal axis 132 and the angle of the side surface relative to the major surface 106. In the simulation shown in FIG. 18, the light extracting elements are embodied as truncated V-groove indentations similar to that shown in FIGS. 6 and 8. The width of the end surface 130 in the direction orthogonal to the longitudinal axis 132 ranges from 25 μm and 225 μm. The angle of the side surface 128 relative to the major surface 106 is set at 15° and 65°. As shown, the percentage of downward light increases with the increase in the angle of the side surface. It is further shown that, for a given side surface angle, the percentage of downward light is not significantly affected with the change in the width of the end surface 130. As discussed above in the context of FIGS. 15 and 16, the change in the width of the end surface 130 primarily affects the light output from the major surface 106.

FIG. 18 also exemplifies that, in some embodiments, the light extracting element 124 is configured to output at most 40 percent of the light incident thereon through the major surface at which the micro-optical element is provided (e.g., as upward light); and is configured to output at least 60 percent of the light incident thereon through the opposing major surface (e.g., as downward light). For example, the light extracting element 124 may be configured to output between 10 to 40 percent of the light incident thereon through the major surface at which the light extracting element is provided (e.g., as upward light), and may output between 60 to 90 percent of the light incident thereon through the opposing major surface (e.g., as downward light).

For each of the embodiments shown in FIGS. 15-17, the angles β1 and β2 are the same as one another. In other embodiments, the angle β1 is different than the angle β2. Similarly, in FIGS. 9-11, the angles θ1 and θ2 are the same. In other embodiments, the angle θ1 is different than the angle θ2. This difference in angles is exemplified in FIG. 19, which shows a light extracting element embodied as a truncated indentation at the first major surface 106 of the light guide 102. The angle β1 formed between the side surface 126 and the normal to the major surface 106 is greater than the angle β2 formed between the side surface 128 and the normal to the major surface 106 (e.g., β1 is about 45° and β2 is about 15°).

As shown in FIG. 19, the side surface 128 may be arranged such that a given portion of light transmitted through the side surface 126 is incident the side surface 128. The light ray 180 propagates in the light guide 102 and is totally internally reflected at the major surface 106 before being incident the side surface 126. The light 180 is reflected at the side surface 126 and is output through the major surface of the light guide 102 (e.g., extracted as downward light). The light ray 182 propagates in the light guide 102 and is initially incident the side surface 126. The light 182 is refracted and is output through the major surface 106 of the light guide 102. Because the side surface 128 is arranged at the angle β2, the light 182 is incident the side surface 128 and is refracted back into the light guide 102. In some embodiments, the light 182 continues to propagate in the light guide 102. In other embodiments (not shown), the light 182 is output from the second major surface 108.

As described above, multiple instances of the light extracting element may be present at one or both of the major surfaces of the light guide (e.g., in a light extracting element array). In some embodiments, the light extracting elements have nominally the same shape and size. In other embodiments, the light extracting elements included in the array have a different size and/or shape. As an example, an array of light extracting elements may include: 1) first light extracting elements each having a first end surface with a first dimension and first side surfaces at respective first angles relative to the major surface; and 2) second light extracting elements each having a second end surface with a second dimension and second side surfaces at respective second angles relative to the major surface. The first light extracting elements may be present in a first percentage of the total number of micro-optical elements that are present in the array, and the second light extracting elements may be present in a second percentage of the total number of light extracting elements that are present in the array. In the example where the light extracting elements are embodied as truncated football-shaped micro-optical elements, one or more of the end surface 130 and side surfaces 126, 130 may differ from among the first and second micro-optical elements with respect to size and/or angle. The presence of multiple types of light extracting elements may provide for a desired light ray angle distribution and/or a desired split ratio.

Turning now to FIG. 20, another exemplary embodiment of a lighting assembly is shown at 200. The lighting assembly 200 includes a light guide 102 configured to propagate light by total internal reflection between its first major surface 106 and its second major surface 108, and a light source 104 positioned adjacent the light input edge 110 of the light guide and configured to edge light the light guide 102. In some embodiments, the light guide 102 and the light source 104 are similar to the light guide 102 and the light source 104 described above with respect to lighting assembly 100. For example, the light guide may have an array of one or more types of light extracting elements 124 embodied as depressions or protrusions shaped as truncated football-shaped micro-optical elements or truncated V-grooves. In other embodiments, the light guide 102 and/or the light source 104 includes any other suitable embodiment. For example, instead of truncated football-shaped micro-optical elements, the micro-optical elements may be shaped as non-truncated football shaped micro-optical elements, each non-truncated football-shaped micro-optical element including a first side surface and a second side surface that come together to form a ridge having ends that intersect the one of the major surfaces 106, 108 at which the micro-optical element is formed.

The lighting assembly 200 further includes a backreflector 250 adjacent one of the major surfaces of the light guide 102. In the embodiment shown in FIG. 20, the backreflector 250 is adjacent the major surface 106. The backreflector 250 is an article having a major surface 252 configured to reflect light emitted from the light guide. In the context of a lighting assembly including a light guide and a backreflector, the major surface 252 of the backreflector 250 faces a major surface of the light guide 102. The backreflector 250 may be used to redirect light that is extracted from the major surface of the light guide (e.g., back through the light guide and out the opposed major surface). The backreflector 250 may be utilized, for example, in lighting designs such as recessed ceiling fixtures where the light extracted from the top surface (e.g., major surface 106) is to be redirected.

FIG. 21 shows an example of a backreflector 250 that includes a specular major surface 252. As exemplified by the light ray 270, this type of backreflector preserves and mirrors the angle of extraction. However, in some embodiments, the backreflector including the specular major surface may cause high-angle glare, as the light reflected by the backreflector may re-enter the light guide and be output from the light guide through the opposite major surface as high-angle light (e.g., greater than 45° from normal to the light guide).

FIG. 22 shows an example of a backreflector 250 that includes a diffuse major surface 252. As exemplified by the light ray 275, the backreflector 250 including the diffuse major surface scatters the light output from the major surface of the light guide 102 that is incident thereon. This may reduce glare as compared with the backreflector including the specular major surface. However, the backreflector including the diffuse major surface also reduces the control over the output light. The light reflected by the backreflector will be scattered, re-enter the light guide, and be output from the light guide through the opposite major surface in a diffuse manner.

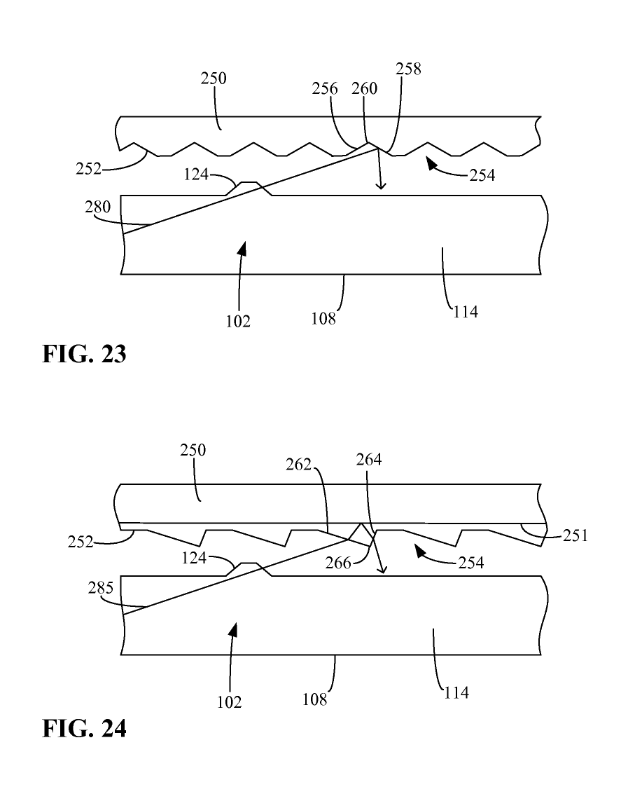

In accordance with the present disclosure, FIG. 23 shows an embodiment of the lighting assembly 200 including a backreflector 250 having a structured major surface 252. The backreflector 250 is provided having light redirecting members 254 embodied as micro- or macro-optical elements of well defined shape at the major surface 250 adjacent the light guide. By providing the backreflector with micro- or macro-optics at the major surface, the specular nature of the backreflector can be preserved while also redirecting the incident light in a direction that is desired for the light output distribution of the fixture as a whole, thus increasing application efficiency of the lighting assembly 200. Hence, the backreflector having the structured major surface 252 may reduce or eliminate high-angle light (glare) from being emitted from the lighting assembly, while also maintaining control over the light ray angle distribution of the output light.

The backreflector 250 having the structured major surface 252 may be particularly applicable for controlling the angle of the light reflected thereby that reenters the light guide 102 and is output from the light guide through the opposite major surface. With some embodiments of the light extracting elements, it is difficult to control the light ray angle distribution of the light that is transmitted by the light extracting element. For example, the light may be extracted at a high angle (e.g., greater than 45° from normal to the light guide) which may be undesired for a given application. By utilizing the backreflector 250 having the structured major surface 252, the light (e.g., the high angle light) may be redirected in a desired manner.

FIG. 23 shows an exemplary embodiment of a backreflector 250 having a structured major surface 252. The backreflector 250 includes light redirecting members 254 of well defined shape at the major surface 252. The light redirecting members 254 are micro- or macro-optic shapes formed as depressions or protrusions in the backreflector. In some embodiments, the micro- or macro-optic shapes may be formed by removing material from the backreflector. In other embodiments, the micro- or macro-optic shapes may be formed by adding material to the backreflector. In the embodiment shown, the surfaces of the light redirect members 254 are reflective surfaces, and incident light is reflected thereby.

The light redirecting members 254 may have any suitable shape. In the example shown in FIG. 23, the light redirecting member 254 (micro- or macro-optic shape) is a v-groove-shaped depression including a first side surface 256 and a second side surface 258 that come together to form a ridge 260. Other exemplary shapes include truncated v-grooves, cones, truncated cones, football shapes, truncated football shapes, pyramids, truncated pyramids, and the like. The light redirecting members 254 may have similar shapes to the light extracting elements 124 described above. In some embodiments, the light redirecting members 254 may have nominally the same shape, size, and/or orientation. In other embodiments, the light redirecting members 254 may vary in one or more of shape, size, surface roughness, and/or orientation.

In some embodiments, each light redirecting member 254 is configured to reduce the angle of the light emitted from the adjacent major surface of the light guide. As shown in FIG. 23, high-angle light 280 output from the major surface 106 of the light guide and incident the light redirecting member 254 is reflected and thereby redirected in a direction that is more perpendicular to the plane of the major surface of the light guide. Accordingly, the light reflected by the backreflector 250 and output from the light guide 102 may be low-angle light (e.g., less than 45° from normal to the light guide).

FIG. 24 shows another exemplary embodiment of a backreflector 250 having a structured major surface 252. The backreflector 250 includes a planar reflective surface 251 and light redirecting elements 254 at the reflective surface. The light redirecting elements are formed of an optically transmissive material and may be bonded to or otherwise in contact with the planar reflective surface 251. In the example shown in FIG. 24, the light redirecting member 254 is a asymmetric v-shaped protrusion including a first side surface 262 and a second side surface 264 that come together to form a ridge 266. As described above, in other embodiments, the light redirecting members may have any suitable shape, and may be configured to reduce the angle of the light emitted from the major surface of the light guide. In some embodiments, the light redirecting members 254 may have nominally the same shape, size, and/or orientation. In other embodiments, the light redirecting members 254 may vary in one or more of shape, size, surface roughness, and/or orientation.

As shown in FIG. 24, high-angle light 285 output from the major surface 106 of the light guide 102 and incident the light redirecting member is refracted at a first surface 262 of the redirecting member 254, incident the reflective surface 251 and reflected, and refracted at the second surface 254 of the redirecting member 254. Accordingly, high-angle light output from a major surface of the light guide and incident the light redirecting member is thereby redirected in a direction that is more perpendicular to the plane of the major surface of the light guide. Accordingly, the light reflected by the backreflector and output from the light guide may be low-angle light.

In this disclosure, the phrase “one of” followed by a list is intended to mean the elements of the list in the alterative. For example, “one of A, B and C” means A or B or C. The phrase “at least one of” followed by a list is intended to mean one or more of the elements of the list in the alterative. For example, “at least one of A, B and C” means A or B or C or (A and B) or (A and C) or (B and C) or (A and B and C).

What is claimed is:

1. A light guide, comprising:
a first major surface;
a second major surface opposed the first major surface;
a light input edge extending between the first major surface and the second major surface, the first major surface and the second major surface configured to propagate light input to the light guide through the light input edge therebetween by total internal reflection;
micro-optical elements at the first major surface, the micro-optical elements embodied as protrusions from the first major surface, each micro-optical element comprising an end surface and a side surface, wherein:
the end surface is configured to reflect at least a portion of the light propagating in the light guide and incident thereon toward the side surface; and
the side surface extends from the first major surface to the end surface at an angle relative to a normal to the first major surface, is configured to reflect and output the portion of the light reflected by the end surface and incident thereon through the second major surface, and is configured to output another portion of the light propagating in the light guide and incident thereon through the first major surface; and
the micro-optical elements are configured to output 60 to 90 percent of the light incident thereon through one of the first and the second major surfaces, and are configured to output 10 to 40 percent of the light incident thereon through the other of the first and the second major surfaces.

2. The light guide of claim 1, wherein for each micro-optical element:
an additional side surface extends from the first major surface to the end surface at an angle relative to the normal to the first major surface, the additional side surface opposed and oppositely sloping relative to the side surface;
the end surface is arcuate in shape and extends along a longitudinal axis of the micro-optical element between ends that intersect the first major surface; and
a width of the end surface extending between the side surface and the additional side surface, orthogonal to the longitudinal axis, is parallel to the first major surface.

3. The light guide of claim 2, wherein the angle of the side surface relative to the normal to the first major surface and the angle of the additional side surface relative to the normal to the first major surface are the same.

4. The light guide of claim 2, wherein the angle of the side surface relative to the normal to the first major surface and the angle of the additional side surface relative to the normal to the first major surface are different.

5. The light guide of claim 1, wherein for each micro-optical element:
an additional side surface extends from the first major surface to the end surface at an angle relative to the normal to the first major surface, the additional side surface opposed and oppositely sloping relative to the side surface;
the end surface is planar and extends along a longitudinal axis of the micro-optical element parallel to the first major surface; and
a width of the end surface extending between the side surface and the additional side surface, orthogonal to the longitudinal axis, is parallel to the first major surface.

6. The light guide of claim 1, wherein the width of the end surface is 5 μm to 500 μm.

7. The light guide of claim 1, wherein the angle between the side surface and the normal to the first major surface is 5° to 85°.

8. The light guide of claim 1, wherein at least one of the respective widths of the end surface and the respective angles of the side surface relative to the normal to the first major surface of the micro-optical elements vary as a function of distance from the light input edge.

9. A lighting assembly, comprising:
the light guide of claim 1; and
a light source adjacent the light input edge of the light guide and configured to edge light the light guide.

10. The lighting assembly of claim 9, further comprising a backreflector adjacent the first major surface of the light guide and configured to reflect light output from the first major surface back into the light guide at an angle such that the light is output from the second major surface of the light guide, the backreflector comprising light redirecting members of well defined shape at a major surface of the backreflector facing the first major surface of the light guide, each light redirecting member configured to redirect the light in a direction that is more perpendicular to the plane of the first major surface of the light guide than a direction of the light output from the first major surface of the light guide.

11. A light guide, comprising:
a first major surface;
a second major surface opposed the first major surface;
a light input edge extending between the first major surface and the second major surface, the first major surface and the second major surface configured to propagate light input to the light guide through the light input edge therebetween by total internal reflection;
micro-optical elements at the first major surface, the micro-optical elements embodied as indentations in the first major surface, each micro-optical element comprising an end surface and a side surface, wherein the side surface extends from the first major surface to the end surface at an angle relative to a normal to the first major surface, is configured to output a portion of the light propagating in the light guide and incident thereon through the first major surface, and is configured to reflect and output another portion of the light incident thereon through the second major surface; and
the micro-optical elements are configured to output 60 to 90 percent of the light incident thereon through one of the first and the second major surfaces, and are configured to output 10 to 40 percent of the light incident thereon through the other of the first and the second major surfaces.

12. The light guide of claim 11, wherein for each micro-optical element:
an additional side surface extends from the first major surface to the end surface at an angle relative to the normal to the first major surface, the additional side surface opposed and oppositely sloping relative to the side surface;
the end surface is arcuate in shape and extends along a longitudinal axis of the micro-optical element between ends that intersect the first major surface; and
a width of the end surface extending between the side surface and the additional side surface, orthogonal to the longitudinal axis, is parallel to the first major surface.

13. The light guide of claim 12, wherein the angle of the side surface relative to the normal to the first major surface and the angle of the additional side surface relative to the normal to the first major surface are the same.

14. The light guide of claim 12, wherein the angle of the side surface relative to the normal to the first major surface and the angle of the additional side surface relative to the normal to the first major surface are different.

15. The light guide of claim 11, wherein for each micro-optical element:
an additional side surface extends from the first major surface to the end surface at an angle relative to the normal to the first major surface, the additional side surface opposed and oppositely sloping relative to the side surface;
the end surface is planar and extends along a longitudinal axis of the micro-optical element parallel to the first major surface; and
a width of the end surface extending between the side surface and the additional side surface, orthogonal to the longitudinal axis, is parallel to the first major surface.

16. The light guide of claim 11, wherein the width of the end surface is 5 μm to 500 μm.

17. The light guide of claim 11, wherein the angle between the side surface and the normal to the first major surface is 5° to 85°.

18. The light guide of claim 11, wherein at least one of the respective widths of the end surface and the respective angles of the side surface relative to the normal to the first major surface of the micro-optical elements vary as a function of distance from the light input edge.

19. A lighting assembly, comprising:
the light guide of claim 11; and
a light source adjacent the light input edge of the light guide and configured to edge light the light guide.

20. The lighting assembly of claim 19, further comprising a backreflector adjacent the first major surface of the light guide and configured to reflect light output from the first major surface back into the light guide at an angle such that the light is output from the second major surface of the light guide, the backreflector comprising light redirecting members of well defined shape at a major surface of the backreflector facing the first major surface of the light guide, each light redirecting member configured to redirect the light in a direction that is more perpendicular to the plane of the first major surface of the light guide than a direction of the light output from the first major surface of the light guide.
